(19) United States
(12) Patent Application Publication
(10) Pub. No.: US 2002/0063827 A1
(43) Pub. Date: May 30, 2002

(54) Optical compensation sheet and process for producing the same

(76) Inventor: Long-Hai Wu, Taoyuan Shien (TW)

Correspondence Address: Mathews, Collins, Shepherd & Gould, P.A., Suite 306, 100 Thanet Circle, Princeton, NJ, 08540-3674, US

(21) Appl. No.: 09/817,479

(22) Filed: Mar. 26, 2001

(30) Foreign Application Priority Data
Nov. 28, 2000 (TW) 089125258

(51) Int. Cl. G02F 1/1335

(52) U.S. Cl. 349/117

(57) ABSTRACT

A structure of an optical compensation sheet and a process for producing the optical compensation sheet. The process includes steps of (a) forming a photo-alignment layer on a substrate, (b) forming a plurality of alignment domains with different directions in the photo-alignment layer, and (c) forming a discotic liquid crystal monomer layer on the photo-alignment layer, wherein the discotic liquid crystal monomer proceeds a tilt align corresponding to the plural alignment domains, thereby producing the optical compensation sheet.

### FIELD OF THE INVENTION

The present invention relates to a structure and a process of an optical compensation sheet, and more particularly to a structure and a process of an optical compensation sheet applied in a liquid crystal display with a multi-domain align.

### BACKGROUND OF THE INVENTION

Presently, the traditional picture tube display is gradually replaced because of the hung volume thereof and the radiation. The potential replacer is the liquid crystal display because the advantages of power-saving and easy carrying are achieved by using the liquid crystal display. Because the current trend is towards larger panel size and higher image resolution in producing the liquid crystal display, the rapid response time and the wide-veiwing angle property become the important issues for next generation of the high quality liquid crystal display. For achieving the wide-veiwing angle, a method using both a multi-domain technology and an optical compensation sheet in a liquid crystal display has been developed. The multi-domain technology is that a single pixel of the liquid crystal display is divided into plural sub-pixels in different liquid crystal rotating directions by a photo-alignment process. Owing to the counterbalance of the optical rotation effect among the sub-pixels, a wider viewing angle could be achieved. In addition, referring to the optical compensation sheet technology which has been widely used, the optical compensation sheet is prepared by using a discotic liquid crystal molecule having regular alignment as material. Because the discotic liquid crystal molecule has a hybrid layer structure and negative birefringence, the effect of compensation can be achieved to wider the viewing angle.

FIG. 1 is a diagram illustrating a liquid crystal display pixel unit using both a two-domain technology and a traditional optical compensation sheet technology according to the prior art. Each pixel unit 10 has two sub-pixels 101 and 102 in different liquid crystal align directions, wherein the arrows represent the liquid crystal align directions as shown in FIG. 1. However, the traditional optical compensation sheet 11 only can provide the discotic liquid crystal molecule in a tilt direction. Hence, the different rotating direction liquid crystal of the sub-pixels 101 and 102 cannot match with the dichotic molecular structure of the optical compensation sheet 11. Thus, the best compensation effect cannot be achieved according to the prior art. Therefore, the purpose of the present invention is to develop a method to deal with the above situations encountered in the prior art.

### SUMMARY OF THE INVENTION

It is therefore an object of the present invention to propose a process for producing an optical compensation sheet having multi-domain with different compensation characteristic to achieve the best compensation effect.

It is therefore another object of the present invention to propose an optical compensation sheet having multi-domain with different compensation characteristic for matching the liquid crystal in different rotating directions of the liquid crystal display to achieve the best compensation effect.

According to one aspect of the present invention, there is proposed a process for producing an optical compensation sheet. The process includes steps of (a) forming a photo-alignment layer on a substrate, (b) forming a plurality of alignment domains in different directions in the photo-alignment layer, and (c) forming a discotic liquid crystal monomer layer on the photo-alignment layer, wherein the discotic liquid crystal monomer proceeds an oriented tilt alignment corresponding to the plural alignment domains, thereby producing the optical compensation sheet.

Certainly, the step (b) can comprise steps of providing a polarized light, illuminating a first domain of the photo-alignment layer by the polarized light in a first polarized direction to obtain a first alignment domain, and illuminating a second domain of the photo-alignment layer by the polarized light in a second polarized direction to obtain a second alignment domain.

Certainly, the photo-alignment layer can be made of an organic polymer material with a photosensitive group.

Certainly, the discotic liquid crystal monomer can have a photopolymerized functional group. The photopolymerized functional group can be selected from one of epoxy and acrylate.

Certainly, after the step (c), the process step can perform a photopolymerization treatment for the discotic liquid crystal monomer layer having the oriented tilt alignment.

Preferably, the step (c) further comprises a step of performing a polymerization treatment for the discotic liquid crystal monomer layer having the oriented tilt alignment. The polymerization treatment is to proceed an illuminating process for the discotic liquid crystal monomer layer having the oriented tilt alignment.

Certainly, the substrate is a transparent substrate.

According to another aspect of the present invention, there is proposed an optical compensation sheet, adapted to be used in a liquid crystal display having a multi-domain align. The optical compensation sheet includes a substrate, and a discotic liquid crystal layer with an alignment treatment, wherein the discotic liquid crystal layer has a plurality of domains in different directions corresponding to the multi-domain align in the liquid crystal display.

Certainly, the optical compensation sheet can further comprise a photo-alignment layer formed between the substrate and the discotic liquid crystal layer and having a plurality of alignment domains in different directions.

The present invention may best be understood through the following description with reference to the accompanying drawings, in which:

### BRIEF DESCRIPTION OF THE DRAWINGS

FIG. 1 is a diagram illustrating a liquid crystal display pixel unit using both a two-domain technology and a traditional optical compensation sheet technology according to the prior art;

FIGS. 2A-2F are schematic sectional views illustrating a process for producing an optical compensation sheet according to a preferred embodiment of the present invention; and

FIG. 3 is a diagram illustrating the optical compensation sheet in FIG. 2 is applied in a multi-domain align liquid crystal display unit according to the present invention.

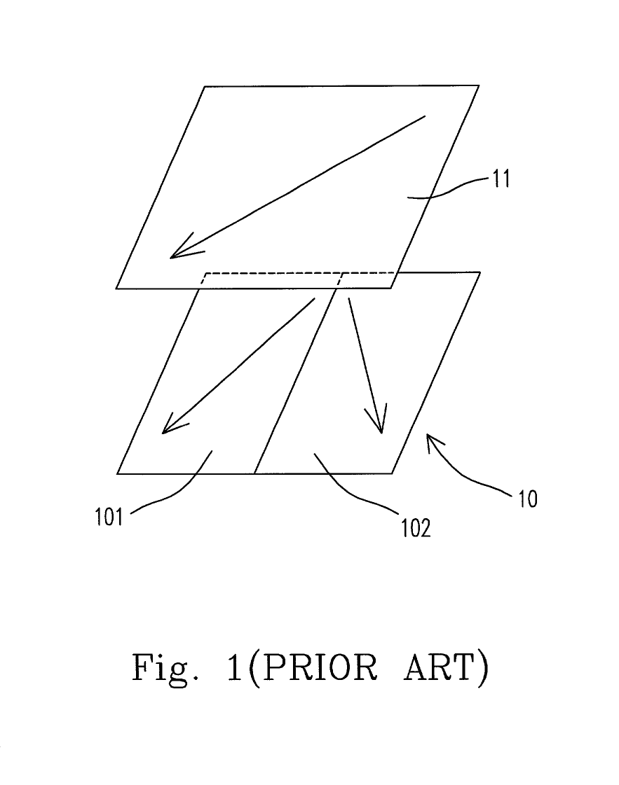

### DETAILED DESCRIPTION OF THE PREFERRED EMBODIMENTS

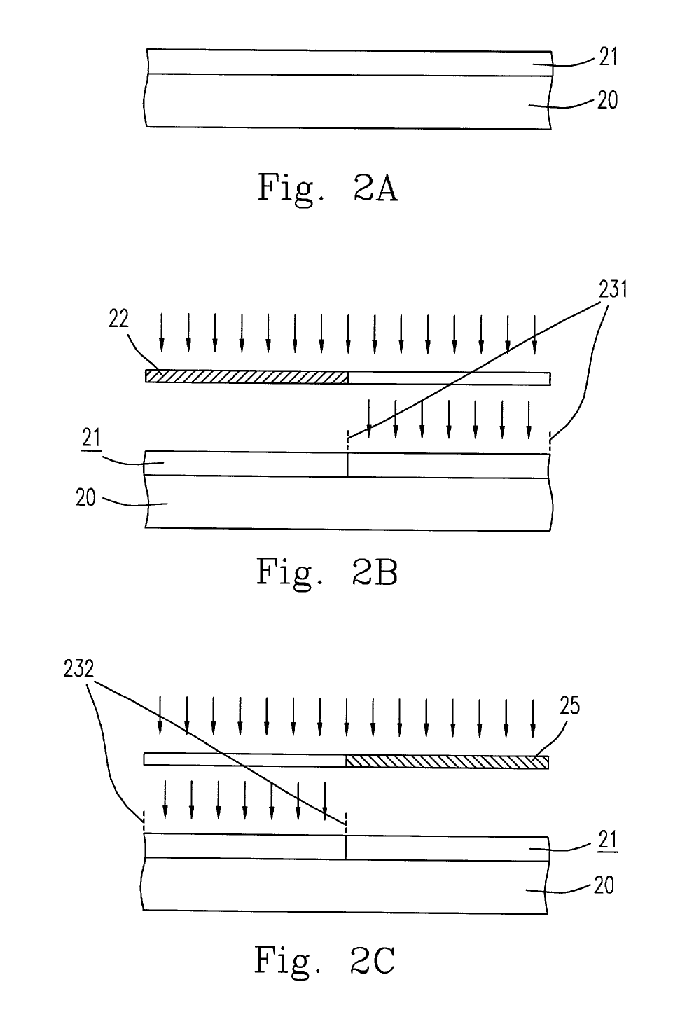

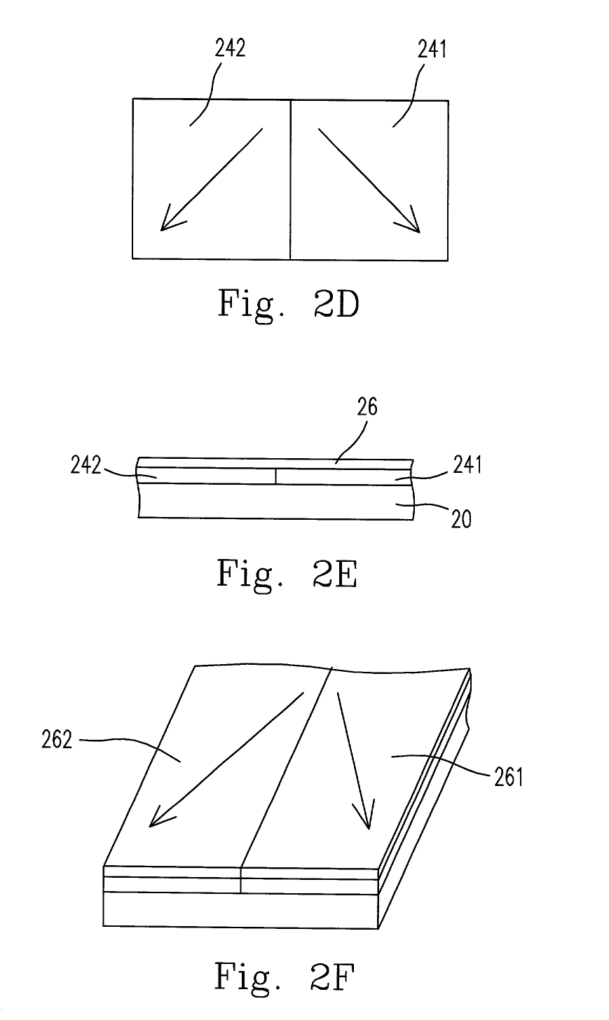

FIGS. 2A-2F are schematic sectional views illustrating a process for producing an optical compensation sheet according to a preferred embodiment of the present invention. As shown in FIG. 2A, a photo-alignment layer 21 is formed on a light-penetrating substrate 20. Sequentially, partial light-penetrating substrate 20 is covered by a photo mask 22 to exposure a first domain 231 as shown in FIG. 2B. The first domain 231 of the photo-alignment layer 21 is illuminated by a polarized light in a first direction for obtaining a first alignment domain 241. Sequentially, partial light-penetrating substrate 20 is covered by a photo mask 25 to exposure a second domain 232 as shown in FIG. 2C. The second domain 232 of the photo-alignment layer 21 is illuminated by a polarized light in a second direction for obtaining a second alignment domain 242. FIG. 2D is a top view of the first alignment domain 241 and the second alignment domain 242, wherein the arrows represent the alignment directions.

After finishing the above procedure, a discotic liquid crystal monomer layer 26 is formed on the photo-alignment layer 21 with the first alignment domain 241 and the second alignment domain 242 as shown in FIG. 2E. Sequentially, the discotic liquid crystal monomer layer 26 is placed at a proper temperature for few minutes to let the discotic liquid crystal monomer proceeds an oriented tilt alignment corresponding to the alignment domains 241 and 242 for obtaining the discotic liquid crystal monomer layer with two different oriented tilt alignments 261 and 262. FIG. 2F shows the optical compensation sheet having multi-domain compensation characteristic, wherein the arrows represent the alignment directions. Sequentially, the discotic liquid crystal monomer layer 261 and 262 are treated by a photopolymerization for producing an optical compensation sheet having a strong mechanical structure via crosslinking.

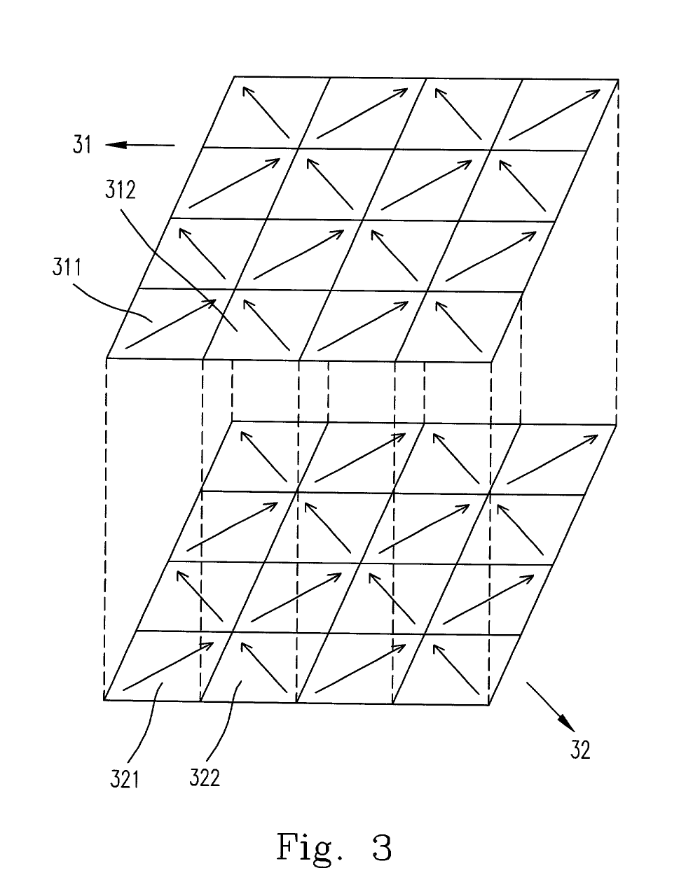

As shown in FIG. 3, the optical compensation sheet 31 finished by above process is applied in a liquid crystal display unit 32 with a multi-domain alignment. The arrows represent the alignment directions in FIG. 3. The optical compensation sheet 31 has plural domains 311 and 312 with different compensation characteristics. Sub-pixels 321 and 322 of the liquid crystal display unit 32 can match the discotic molecular structure of the domains 311 and 312 in the optical compensation sheet 31, respectively, for achieving the best compensation effect.

In addition, for the above structure and process, the photo-alignment layer can be made of an organic high polymer material with a photosensitive group, and the discotic liquid crystal monomer can have a photopolymerized functional group such as epoxy and acrylate. The polarized light for performing photo-alignment procedure can use a polarized light in ultraviolet band.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A process for producing an optical compensation sheet, comprising steps of:
(a) forming a photo-alignment layer on a substrate;
(b) forming a plurality of alignment domains in different directions in said photo-alignment layer; and
(c) forming a discotic liquid crystal monomer layer on said photo-alignment layer, wherein said discotic liquid crystal monomer proceeds an oriented tilt alignment corresponding to said a plurality of alignment domains, thereby producing said optical compensation sheet.

2. The process according to claim 1, wherein said step (b) comprises steps of:
providing a polarized light;
illuminating a first domain of said photo-alignment layer by said polarized light in a first polarized direction to obtain a first alignment domain; and
illuminating a second domain of said photo-alignment layer by said polarized light in a second polarized direction to obtain a second alignment domain.

3. The process according to claim 1, wherein said photo-alignment layer is made of an organic polymer material with a photosensitive group.

4. The process according to claim 1, wherein said discotic liquid crystal monomer has a photopolymerized functional group.

5. The process according to claim 4, wherein said photopolymerized functional group is one of epoxy and acrylate.

6. The process according to claim 5, after said step (c) further comprising step of performing a photopolymerization treatment for said discotic liquid crystal monomer layer having said oriented tilt align.

7. The process according to claim 1, wherein said step (c) further comprises a step of performing a polymerization treatment for said discotic liquid crystal monomer layer having said oriented tilt alignment.

8. The process according to claim 7, wherein said polymerization treatment is to proceed an illuminating process for said discotic liquid crystal monomer layer having said oriented tilt align.

9. The process according to claim 1, wherein said substrate is a transparent substrate.

10. An optical compensation sheet, adapted to be used in a liquid crystal display having a multi-domain align, comprising:
a substrate; and
a discotic liquid crystal layer with an alignment treatment, wherein said discotic liquid crystal layer has a plurality of domains with different directions corresponding to said multi-domain alignment in said liquid crystal display.

11. The optical compensation sheet according to claim 10, further comprising a photo-alignment layer formed between said substrate and said discotic liquid crystal layer and having a plurality of alignment domains in different directions.
